(19) United States
(12) Patent Application Publication
(10) Pub. No.: US 2016/0014500 A1
(43) Pub. Date: Jan. 14, 2016

(54) Speaker

(71) Applicant: YAMAHA CORPORATION, Hamamatsu-shi, Shizuoka (JP)

(72) Inventors: Yasuaki TAKANO, Kikugawa-shi, Shizuoka (JP); Kunimasa MUROI, Hamamatsu-shi, Shizuoka (JP)

(21) Appl. No.: 14/770,733

(22) PCT Filed: Feb. 26, 2014
(86) PCT No.: PCT/JP2014/054761

§ 371 Date: Aug. 26, 2015

(30) Foreign Application Priority Data
Feb. 27, 2013 (JP) 2013-037678

(51) Int. Cl. H04R 1/28; H04R 19/02

(52) U.S. Cl. CPC H04R 1/288; H04R 19/02; H04R 2201/021

(57) ABSTRACT

A speaker provided with an electrostatic speaker unit in a shape of a sheet, includes: a sound absorbing material having a first face which is disposed on a side of a first face of the electrostatic speaker unit, and which has an area equal to or larger than an area of the first face of the electrostatic speaker unit; and a holding member holding the electrostatic speaker unit and the sound absorbing material. A second face of the sound absorbing material, which is opposite to the first face thereof, is disposed so as to be opposed to a face of a sound insulating element, and an area of the face of the sound insulating element is equal to or larger than the area of the first face of the electrostatic speaker unit.

### TECHNICAL FIELD

The present invention relates to a speaker emitting sounds according to sound signals which are inputted thereto.

### BACKGROUND ART

As a speaker of a common type, a dynamic speaker which is provided with a dynamic speaker unit has been conventionally known (Refer to Patent Document 1). The dynamic speaker unit is provided with a permanent magnet for vibrating a vibration plane with an electromagnetic force.

Because the dynamic speaker unit is heavy due to provision of the permanent magnet, sufficient strength is required for installing the speaker on a ceiling or a wall.

In view of the above, it is considered to use an electrostatic speaker in a shape of a sheet. Because the electrostatic speaker in a shape of a sheet is lightweight, it can be installed on the ceiling or the wall, without requiring particular reinforcement.

### PRIOR ART DOCUMENT

### Patent Document

Patent Document 1: JP-A-S63-90299

### SUMMARY OF THE INVENTION

### Problems that the Invention is to Solve

However, the electrostatic speaker outputs plane waves from both faces of the vibration plane in a direction of a normal of the vibration plane. Therefore, in case where one of the faces is installed on the ceiling or the wall, sound waves outputted from the one face are reflected by the ceiling or the wall, and interfere with the sound waves which are outputted from the other face of the vibration plane, in some cases.

In view of the above, an object of the invention is to provide a lightweight and thin-shaped speaker which can be installed on a ceiling or a wall, while suppressing interference.

### Means for Solving the Problems

A speaker according to the invention is provided with an electrostatic speaker unit, and comprises: a sound absorbing material having a first face which is disposed on a side of a first face of the electrostatic speaker unit, and which has an area equal to or larger than an area of the first face of the electrostatic speaker unit; and a holding member holding the electrostatic speaker unit and the sound absorbing material, wherein a second face of the sound absorbing material, which is opposite to the first face thereof, is disposed so as to be opposed to a face of a sound insulating element, and an area of the face of the sound insulating element is equal to or larger than the area of the first face of the electrostatic speaker unit.

Generally, the speaker radially outputs sound waves which are in opposite phases to each other, frontward and backward in opposite directions. The sound waves which are outputted in one direction turn back in the other direction, and hence, interference occurs. Particularly, a low-pitched sound is likely to interfere, since the low-pitched sound has lower directivity than a high-pitched sound. Therefore, the speaker of a common type must be provided with a baffle and an enclosure for preventing the interference. Moreover, the enclosure requires a sufficient space and capacity for the purpose of securing amplitude of the vibration plane.

On the other hand, the electrostatic speaker unit outputs the plane waves having strong directivity in the direction of the normal of the vibration plane (that is, a front face side and a back face side of the vibration plane), and therefore, the outputted plane waves are unlikely to be turned back in the opposite directions. As the results, the speaker according to the invention which is provided with the sound absorbing material on its back face cancels only the sounds (the plane waves) in the backward direction, and prevents the interference due to turning back, without providing the baffle and enclosure.

Moreover, the electrostatic speaker unit hardly outputs the low-pitched sound which is easily turned back and unlikely to be absorbed. Therefore, in the speaker according to the invention, the sounds in the back face direction can be sufficiently cancelled only by the sound absorbing material.

Further, the sound absorbing material is disposed between the electrostatic speaker unit and the sound insulating material. Because the first face (the front face) of the sound absorbing material has an area equal to or larger than an area of the first face of the electrostatic speaker unit, the sounds which are outputted from the first face (the back face) of the electrostatic speaker unit are absorbed by the sound absorbing material. Even though remaining sounds which are not absorbed by the sound absorbing material exist, passage of the sounds is prevented by the sound insulating element, and the sounds will not be reflected by any other object to interfere with the sounds which are outputted from the second face (the front face) of the electrostatic speaker unit. It is to be noted that the sound insulating element may be the wall or ceiling itself, or a thin sound insulating member may be separately provided.

In this manner, even though the speaker according to the invention has a lightweight and thin structure which is not provided with the baffle and the enclosure, it is possible to prevent the sounds which are outputted from the first face of the electrostatic speaker unit from being reflected by the ceiling or the wall, for example, thereby to interfere with direct sounds which are outputted from the second face of the electrostatic speaker unit. Accordingly, the speaker according to the invention can be installed by directing the first face (the back face) of the electrostatic speaker unit to the ceiling, the wall, and so on.

Moreover, the face of the sound insulating element may be a wall face.

The holding member may be attached to the wall face.

Further, the sound insulating element may be a sound insulating material, and this sound insulating material may be abutted against the second face of the sound absorbing material.

Still further, the holding member may be in a shape of a case body which integrally contains the electrostatic speaker unit, the sound absorbing material, and the sound insulating material.

In this structure, even though an object for reflecting the sounds may exist on the first face side of the electrostatic speaker unit, it is possible to install the speaker, because the sounds which are outputted from the first face side of the electrostatic speaker unit are not emitted to the exterior. Further, the speaker is excellent in portability and installing performance, because the holding member integrally contains the electrostatic speaker unit, the sound absorbing material, and the sound insulating material.

It is desirable that the holding member is formed of a cardboard or polypropylene foamed sheet.

The cardboard and the polypropylene foamed sheet are lightweight as material, while having required strength for holding the electrostatic speaker unit, the sound absorbing material, and the sound insulating material. Therefore, the cardboard and the polypropylene foamed sheet are desirable as the material for installing the lightweight speaker on the ceiling, the wall or so.

Moreover, the holding member may be provided with a medium attaching face, on a side opposed to a second face of the electrostatic speaker unit.

Further, the medium attaching face may be formed of such material that the medium can be repeatedly removed therefrom.

In this case, the speaker can be installed in such a manner that the medium for giving visual information (a poster, for example) is applied to the medium attaching face.

Moreover, the sound absorbing material is desirably formed of polyurethane foam.

The polyurethane foam can be molded so as to have a smooth surface, as compared with the sound absorbing material formed of glass wool or the like. In case where the electrostatic speaker unit is held in a manner superposed on the sound absorbing material formed of polyurethane foam having the smooth surface, the surface of the electrostatic speaker unit can be maintained in a smooth shape. Moreover, the polyurethane foam has high sound absorbing efficiency and good workability, and can be worked into a plate-like shape having a uniform thickness at a low cost.

### Advantage of the Invention

According to the invention, the speaker can prevent interference, even though it is installed on the ceiling or the wall, while utilizing characteristics of the electrostatic speaker unit which is thin-shaped and lightweight.

### BRIEF DESCRIPTION OF THE DRAWINGS

FIG. 1 is a perspective view of a lower face of a speaker 1 according to an embodiment 1.

FIG. 2 is a view showing the speaker 1 according to the embodiment 1 in an installed state.

FIG. 3 is a graph showing sound emitting characteristic of the speaker 1 according to the embodiment 1.

FIG. 4(A) and FIG. 4(B) are views showing a speaker 2 according to an embodiment 2.

FIG. 5 is a perspective view of a front face of a speaker 2A according to a modification of the speaker 2.

FIG. 6(A) and FIG. 6(B) are views showing the speaker 2A in installed states.

FIG. 7(A) is a perspective view of a lower face of a speaker 3 according to an embodiment 3, and FIG. 7 (B) is a view showing the speaker 3 in an installed state.

### MODE FOR CARRYING OUT THE INVENTION

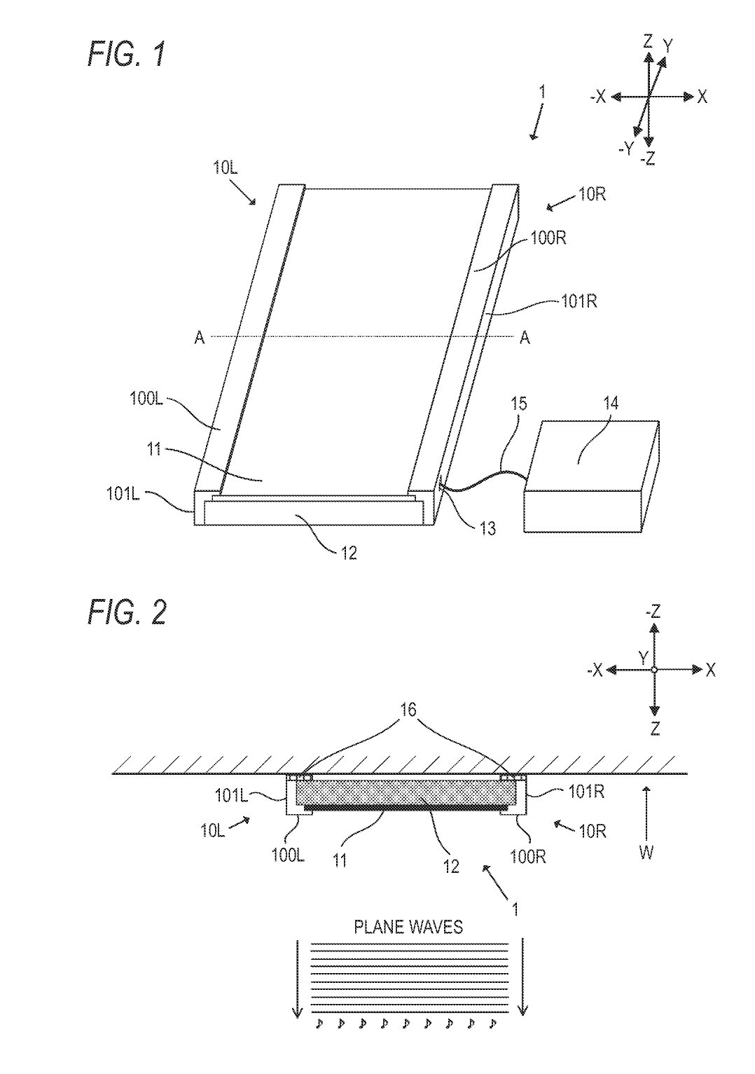

A speaker 1 according to an embodiment 1 will be described referring to FIGS. 1 and 2. FIG. 1 is a perspective view of a front face of the speaker 1. FIG. 2 is a sectional view taken along a line A-A, when the speaker 1 is installed on a wall face W.

The speaker 1 is connected to an amplifier 14 by way of a speaker cable 15. The speaker 1 emits sounds according to sound signals which are outputted from the amplifier 14.

As shown in FIG. 1, the speaker 1 has a rectangular parallelepiped shape which is longer in a direction of height (Y, −Y directions in the drawing) and thinner in a direction of thickness (Z, −Z directions in the drawing). Respective heights of a front face (the face at the Z side in the drawing) and a back face (the face at the −Z side in the drawing) of the speaker 1 are equal to a size A0 according to Japanese Industrial Standard of paper. The front face and the back face of the speaker 1 are slightly longer (by 3 cm, for example) in width (in X, −X directions in the drawing) than the size A0 according to Japanese Industrial Standard of paper. A thickness of the speaker 1 is 4 cm, for example. In FIG. 1, a face of the speaker 1 at the Y side is referred to as an upper face, a face at the −Y side is referred to as a lower face, a face at the X side is referred to as a right side face, and a face at the −X side is referred to as a left side face. However, the sizes of the front face and the back face of the speaker 1 are not limited to the size A0 according to Japanese Industrial Standard of paper, but optional. For example, the sizes of the front face and the back face of the speaker 1 may be equal to a size B1 or B2 according to Japanese Industrial Standard of paper. Alternatively, the front face and the back face may have such sizes according to other standards (for example, standard of size for architectural material) or may have heights and widths which are not based on any standard.

The speaker 1 includes a holding frame 10L, a holding frame 10R, an electrostatic speaker unit 11, and a sound absorbing sponge 12.

As shown in FIG. 1, the electrostatic speaker unit 11 is a thin-shaped and lightweight speaker unit in a shape of a rectangular sheet which is longer in the direction of height. A surface of the electrostatic speaker unit 11 (an X-Y plane) has substantially the same shape as the front face of the speaker 1, and has a slightly shorter width (by 3 cm, for example) than the speaker 1. A thickness of the electrostatic speaker unit 11 is 1.5 mm, for example.

The sound absorbing sponge 12 has a rectangular parallelepiped shape which is longer in the direction of height and thin in thickness, as shown in FIG. 1. A height of the sound absorbing sponge 12 is equal to the height of the electrostatic speaker unit 11. A width of the sound absorbing sponge 12 is longer than the width of the electrostatic speaker unit 11 by 1 cm, for example, respectively at both sides in the lateral direction. The thickness of the sound absorbing sponge 12 is, for example, 3 cm. The sound absorbing sponge 12 is formed of material having light weight and high sound absorbing efficiency (polyurethane foam, for example).

As shown in FIG. 1, a front face of the sound absorbing sponge 12 (a face at the Z side in the drawing) is abutted against a back face of the electrostatic speaker unit 11 (a face at the −Z side in the drawing).

The holding frame 10L and the holding frame 10R are respectively formed of an expanded sheet having light weight and sufficient strength for holding the electrostatic speaker unit 11 and the sound absorbing sponge 12. The expanded sheet is molded by extruding and expanding polypropylene. The holding frame 10L and the holding frame 10R are respectively longer in the direction of height, as shown in FIG. 1. The holding frame 10L (and the holding frame 10R) is disposed on the left side face (and the right side face) of the speaker 1. The holding frame 10L includes a front face part 100L and a side face part 101L. As shown in FIG. 2, the holding frame 10L has an L-shape, when the speaker 1 is seen in the −Y direction.

The holding frame 10R includes a front face part 100R and a side face part 101R. The holding frame 10R has a laterally inverted L-shape, when the speaker 1 is seen in the −Y direction.

As shown in FIG. 2, the front face part 100L and the front face part 100R are respectively disposed at a front side of the speaker 1 ahead of the electrostatic speaker unit 11. The front face part 100L and the front face part 100R are respectively disposed so as to be superposed on right and left edges of the electrostatic speaker unit 11, when the speaker 1 is seen from the front side.

The speaker 1 is installed in such a manner that its back face is directed to the wall face W, as shown in FIG. 2. Specifically, the sound absorbing sponge 12 is disposed at the nearest position to the wall face W. Aback side of the holding frame 10L and a part of the back face of the sound absorbing sponge 12 are respectively attached to the wall face W by means of double-faced tapes 16. A back side of the holding frame 10R is also attached to the wall face W by means of the double-faced tape 16. It is to be noted that an area of the wall face W is equal to or larger than an area of the back face of the electrostatic speaker unit 11.

Because the holding frame 10L and the holding frame 10R are attached, the front face part 100L and the front face part 100R respectively press the right edges and left edges of the electrostatic speaker unit 11 and the sound absorbing sponge 12 to an upper side in FIG. 2 (a side where the wall face W exists). As the results, the holding frame 10L and the holding frame 10R respectively hold the electrostatic speaker unit 11 and the sound absorbing sponge 12 in a state disposed on the wall face W, as shown in FIG. 2.

A hole 13 through which the speaker cable 15 is passed is provided on the side face part 101R. One end of the speaker cable 15 is connected to the electrostatic speaker unit 11. The other end of the speaker cable 15 is connected to the amplifier 14. The sound signals outputted from the amplifier 14 vibrate a vibration plane inside the electrostatic speaker unit 11 in a direction of a normal of the vibration plane. As the results, the electrostatic speaker unit 11 outputs plane waves which are parallel to the front face of the speaker 1 in the front face direction and in the back face direction.

The plane waves which are outputted in the back face direction of the speaker 1 are absorbed by the sound absorbing sponge 12. The sound absorbing sponge 12 can absorb all the plane waves, because an area of the front face of the sound absorbing sponge 12 is larger than an area of the back face of the electrostatic speaker unit 11. In case where some of the plane waves are not absorbed but pass through the sound absorbing sponge 12, the relevant plane waves do not pass the wall face W corresponding to the sound insulating element of the invention. Reflected waves which are reflected by the wall face W advance in a direction rightly opposite to the plane waves which are arriving at the wall face W. Specifically, the reflected waves returns to the back face (the face at the −Z side) of the sound absorbing sponge 12, and do not spread outward of the speaker 1. The reflected waves are absorbed again, when they arrived at the sound absorbing sponge 12. As the results, the plane waves which are outputted from the electrostatic speaker unit 11 in the back face direction of the speaker 1 are absorbed by the sound absorbing sponge 12, and do not interfere with the plane waves which are outputted in the front face direction of the speaker 1.

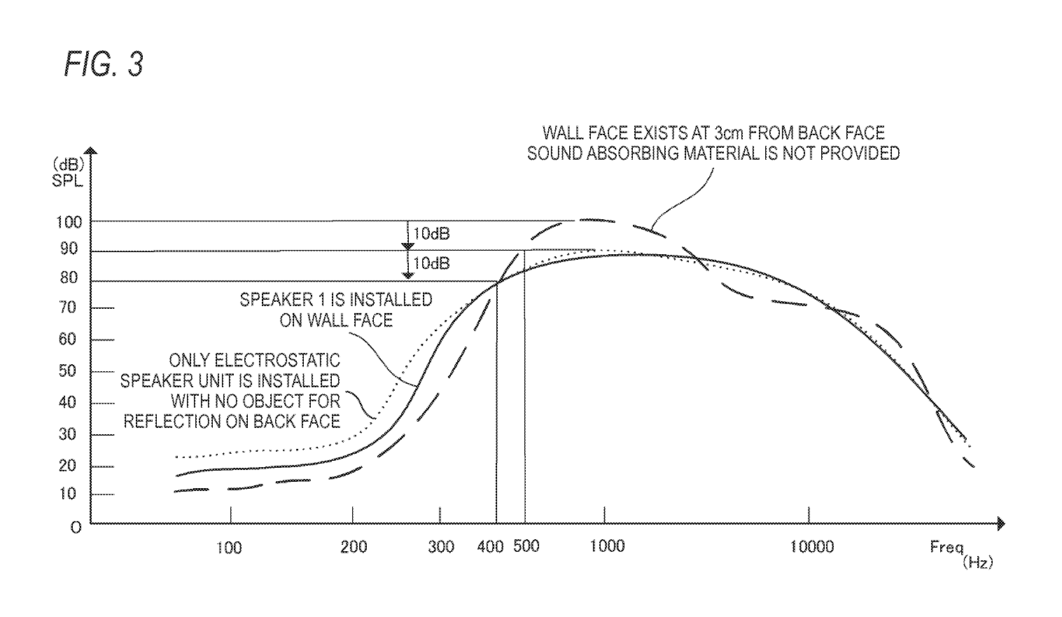

FIG. 3 is a graph showing sound emitting characteristics of the speaker 1. The X axis shows frequencies of the sounds which are emitted from the speaker 1. The Y-axis shows sound pressures of the sounds which are emitted from the speaker 1. The sound pressures are measured at a position separated by lm from the speaker 1 in the front face direction of the speaker 1.

In FIG. 3, a solid line represents the sound emitting characteristics of the speaker 1, when the speaker 1 is installed on the wall face W. A dotted line represents the sound emitting characteristics of only the electrostatic speaker unit 11 which is not provided with the sound absorbing sponge 12, and the sound emitting characteristics, when an object for reflecting the sound (the wall face W, for example) is not disposed in the back face direction of the electrostatic speaker unit 11. In short, the dotted line represents an ideal sound emitting characteristics, because the sounds which are outputted in the back face direction of the electrostatic speaker unit 11 are not reflected nor turned back in the front face direction. A broken line represents the sound emitting characteristics, when the sound absorbing sponge 12 is not provided, and the wall face W is disposed at a position separated by 3 cm in the backward direction of the electrostatic speaker unit 11. In short, the broken line represents the sound emitting characteristics, when the sounds reflected by the wall face W interfere with direct sounds which are emitted at the front face side of the electrostatic speaker unit 11.

When the direct sounds are subjected to interference of the reflected sounds, the direct sounds are enforced in case where the sounds are in the same phase, but weakened in case where the sounds are in counter phases. Accordingly, as shown by the broken line in FIG. 3, the sound pressure of the direct sounds which are subjected to the interference becomes higher or lower than the ideal sound emitting characteristics, in a specific frequency zone. Particularly, the sound pressure of the direct sounds which are subjected to the interference remarkably drops in a low frequency zone. In an example in FIG. 3, in the frequency zone which has a sound pressure lower than a peak sound pressure by 10 dB (hereinafter referred to as reproduced low frequency), the reproduced low frequency of the ideal sound emitting characteristics is 400 Hz, while the reproduced low frequency in case where the direct sounds are subjected to the interference is 500 Hz.

On the other hand, the sound emitting characteristics of the speaker 1 comes near to the ideal sound emitting characteristics, as compared with the sound emitting characteristics which is shown by the broken line in FIG. 3. Particularly, the sound emitting characteristics of the speaker 1 in the frequency zone higher than 400 Hz is substantially equal to the ideal sound emitting characteristics. Moreover, the reproduced low frequency of the speaker 1 is 400 Hz, and equal to the reproduced low frequency of the ideal sound emitting characteristics. Further, also in the frequency zone lower than 400 Hz, the sound emitting characteristics of the speaker 1 has the higher sound pressure than the sound emitting characteristics which is shown by the broken line in FIG. 3, and comes near to the ideal sound emitting characteristics. This means that the speaker 1 prevents drop of the sound pressure in the low frequency zone due to the interference.

As described above, the speaker 1 can suppress the interference, even in case where the back face thereof is installed on the wall face W, while utilizing characteristics of the electrostatic speaker unit 11 which is lightweight and thin-shaped.

Moreover, it would be sufficient that the front face of the sound absorbing sponge 12 has at least the same area as the back face of the electrostatic speaker unit 11, because the plane waves do not spread radially.

The speaker 1 need not be installed on the wall face W, but may be installed on a ceiling. Alternatively, the speaker 1 may be attached to a resin plate having sound insulating effect. For example, the speaker 1 may be attached to a partition formed of the resin plate. In this case, it is possible to install the speaker 1 in any place not only on the wall face and ceiling.

Moreover, although the speaker 1 is provided with the sound absorbing sponge 12 which is formed of polyurethane foam, as the material for absorbing sounds, other materials may be also used.

For example, the sound absorbing material having higher sound absorbing efficiency can absorb the sounds, even though it has a thin thickness. Therefore, it is possible to reduce the thickness of the speaker 1. As the sound absorbing material having the higher sound absorbing efficiency, polyurethane foam and glass wool are favorable.

Moreover, for example, in case where the sound absorbing material having a smoother surface is used, a vibration plane and an electrode face of the electrostatic speaker unit 11 in contact with the sound absorbing material are likely to become smooth. As the results, the speaker 1 suppresses distortion of the plane waves due to undulated shapes of the vibration plane and electrode face of the electrostatic speaker unit 11, so that directivity of the plane waves can be easily maintained. As the sound absorbing material which easily makes the surface smooth, polyurethane foam or glass wool provided with a flat and smooth film attached to its surface is favorable.

Moreover, the sound absorbing material having higher strength, for example, improves installing performance, because such material can keep its shape by itself. As the sound absorbing material having higher strength, glass wool is favorable. Moreover, the sound absorbing material having better workability can be easily worked according to the shape of the electrostatic speaker unit 11 (in a plate-like shape, for example), and the thickness can be easily adjusted (the thickness is made uniform, for example). As the sound absorbing material having good workability, polyurethane foam or non-woven fabric (material formed of industrial fiber or animal hair) is favorable. Polyurethane foam is superior to other material in view of low cost.

As described above, polyurethane foam is most favorable as the sound absorbing material of the speaker 1, not only because polyurethane foam has the high sound absorbing efficiency, and makes the surface of the electrostatic speaker unit 11 in contact therewith smooth, but also because it has excellent workability and low cost.

Moreover, material for the holding frame 10L and the holding frame 10R is not limited to polypropylene. For example, in case where the material having higher strength is used, it is possible to hold the electrostatic speaker unit 11 and the sound absorbing sponge 12, even though the frames are made thinner or smaller. As the material having the higher strength, a PET plate or a resin plate reinforced with carbon fibers is favorable.

For example, more lightweight material can make the speaker 1 lightweight, and enhances installing performance of the speaker 1. As the lightweight material, a polypropylene foamed sheet, a cardboard, or a resin plate reinforced with carbon fibers is favorable.

For example, the material having the better workability can be easily worked according to the shapes of the electrostatic speaker unit 11 and the sound absorbing sponge 12. As the material having the better workability, a cardboard or a polypropylene foamed sheet is favorable. Besides, the cardboard and the polypropylene foamed sheet are low-cost.

As described above, the cardboard and polypropylene foamed sheet are most favorable as the material for holding the speaker 1, because they have sufficient strength for holding the electrostatic speaker unit 11 and the sound absorbing sponge 12, and for maintaining arrangement of the speaker on the wall face W, and further, they are lightweight, can be easily worked, and are low-cost.

Moreover, the shape of the holding frame 10L and the holding frame 10R is not limited to the L-shape (or the laterally inverted L-shape), as seen in the direction of height, but may be C-shape, for example. Any shape maybe used, provided that the arrangement is maintained.

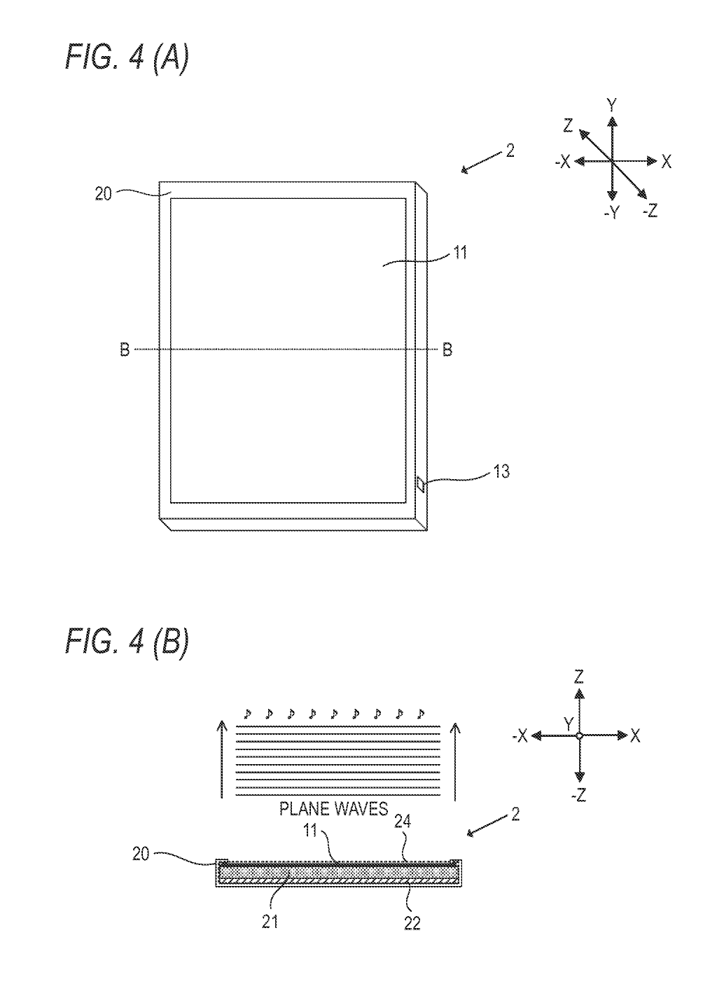

Then, a speaker 2 according to an embodiment 2 will be described referring to FIGS. 4(A) and 4(B). FIG. 4(A) is a perspective view of a front face of the speaker 2. FIG. 4(B) is a sectional view taken along a line B-B. Description of a structure of the speaker 2 which is overlapped with that of the speaker 1 will be omitted.

The speaker 2 has such a structure that the electrostatic speaker unit 11, a sound absorbing sponge 21, and a sound insulating material 22 are held by a case body 20, in place of the holding frame 10L and the holding frame 10R which are provided on the speaker 1.

As shown in FIG. 4(B), the speaker 2 includes the electrostatic speaker unit 11, the case body 20, the sound absorbing sponge 21, and the sound insulating material 22.

A shape and material of the sound absorbing sponge 21, and its relative arrangement with respect to the electrostatic speaker unit 11 are the same as those of the sound absorbing sponge 12 of the speaker 1.

The sound insulating material 22 is in a form of a resin plate having a thickness of 3 mm. As shown in FIG. 4(B), a front face (the face at the Z side) of the sound insulating material 22 is abutted against a back face (the face at the −Z side) of the sound absorbing sponge 21, at an opposite side to the side where the electrostatic speaker unit 11 is disposed. A shape of the front face of the sound insulating material 22 corresponds to a shape of the back face of the sound absorbing sponge 21. Specifically, an area of the front face of the sound insulating material 22 is larger than the area of the back face of the electrostatic speaker unit 11. However, it would be sufficient that the area of the front face of the sound insulating material 22 is at least equal to the area of the back face of the electrostatic speaker unit 11, because the plane waves do not spread radially.

The case body 20 is a box having a rectangular parallelepiped shape which is longer in the direction of height (the Y, −Y direction in the drawing) and thinner in the direction of thickness (the Z, −Z direction in the drawing), as shown in FIG. 4(A). The front face of the case body 20 is open so that the front face of the electrostatic speaker unit 11 except its edges may be exposed. The other faces of the case body 20 are formed of a cardboard having a thickness of 5 mm.

As shown in FIG. 4(B), the case body 20 integrally contains the electrostatic speaker unit 11, the sound absorbing sponge 21, and the sound insulating material 22. Specifically, a height (the Y, −Y direction in the drawing) and a width (the X, −X direction in the drawing) of an interior 24 of the case body which is shown by a dotted line in FIG. 4(B) are slightly larger than the size A0 according to Japanese Industrial Standard of paper, respectively. A depth (the Z, −Z direction in the drawing) of the interior 24 of the case body is equal to a total length of the thicknesses of the electrostatic speaker unit 11, the sound absorbing sponge 21, and the sound insulating material 22. However, the height and width of the interior 24 of the case body are not limited to the size A0 according to Japanese Industrial Standard of paper, but maybe optional. It would be sufficient that the height and width are so set as to contain the electrostatic speaker unit 11, the sound absorbing sponge 21, and the sound insulating material 22.

The plane waves which have passed through the sound absorbing sponge 21 arrive at the sound insulating material 22. Because the plane waves are not allowed to pass the sound insulating material 22, the sound will not be outputted in the back face direction. In case where a part of the plane waves should pass through the sound insulating material 22, the back face of the case body 20 also functions as a sound insulating material, and prevents the sounds from being outputted in the back face direction of the speaker 2.

The sounds will not be outputted from the back face of the speaker 2, because the sound absorbing sponge 21 and the sound insulating material 22 are provided. Therefore, the speaker 2 can be installed, even in case where an object for reflecting the sounds exists on the backside. Further, because the speaker 2 is provided with the case body 20, the speaker 2 is excellent in portability and installing performance.

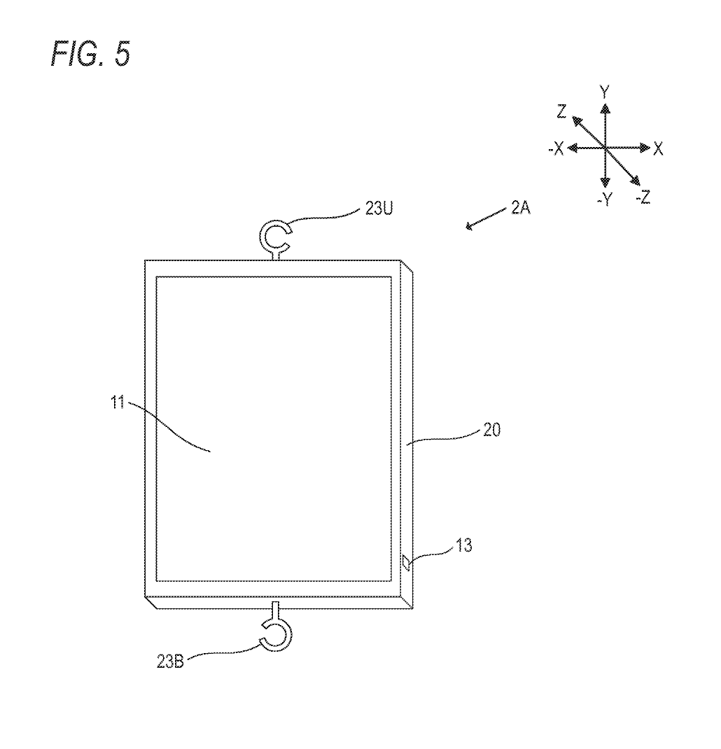

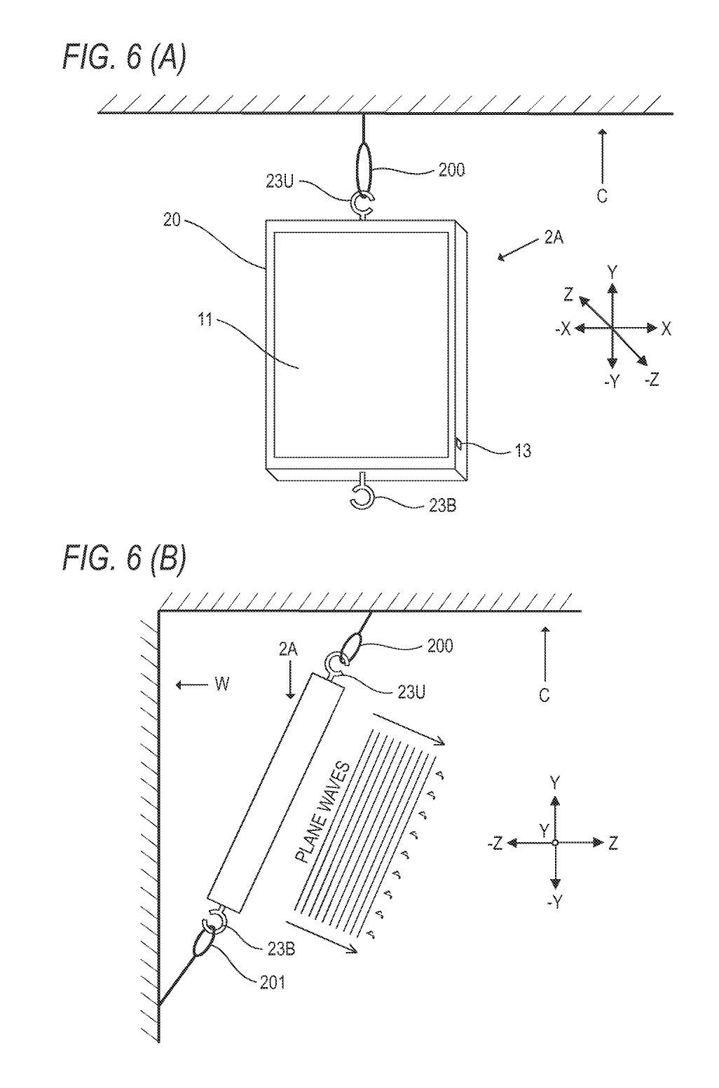

Then, referring to FIGS. 5, 6A), and 6(B), a speaker 2A which is a modification of the speaker 2 will be described. FIG. 5 is a perspective view of a front face of the speaker 2A. FIGS. 6(A) and 6(B) are views for showing manners of installing the speaker 2A. Description of a structure of the speaker 2A which is overlapped with that of the speaker 2 will be omitted.

The speaker 2A is different from the speaker 2 in that the speaker 2A can be installed by hanging. The speaker 2A includes the electrostatic speaker unit 11, the case body 20, the sound absorbing sponge 21, the sound insulating material 22, a hook 23U, and a hook 23B. The hook 23U is attached to an upper face of the case body 20. The hook 23B is attached to a lower face of the case body 20.

By hooking the hook 23U on a bracket 200 which is fixed to a ceiling C, as shown in FIG. 6(A), the speaker 2A is installed by hanging. Moreover, by hooking the hook 23U on the bracket 200 which is fixed to the ceiling C, and by hooking the hook 23B on a bracket 201 which is fixed to the wall face W, as shown in FIG. 6(B), the speaker 2A is diagonally installed by hanging. It is possible to install the speaker 2A, even though the back face is directed to the wall face or four corners of a room, because the sounds are not outputted in the back face direction.

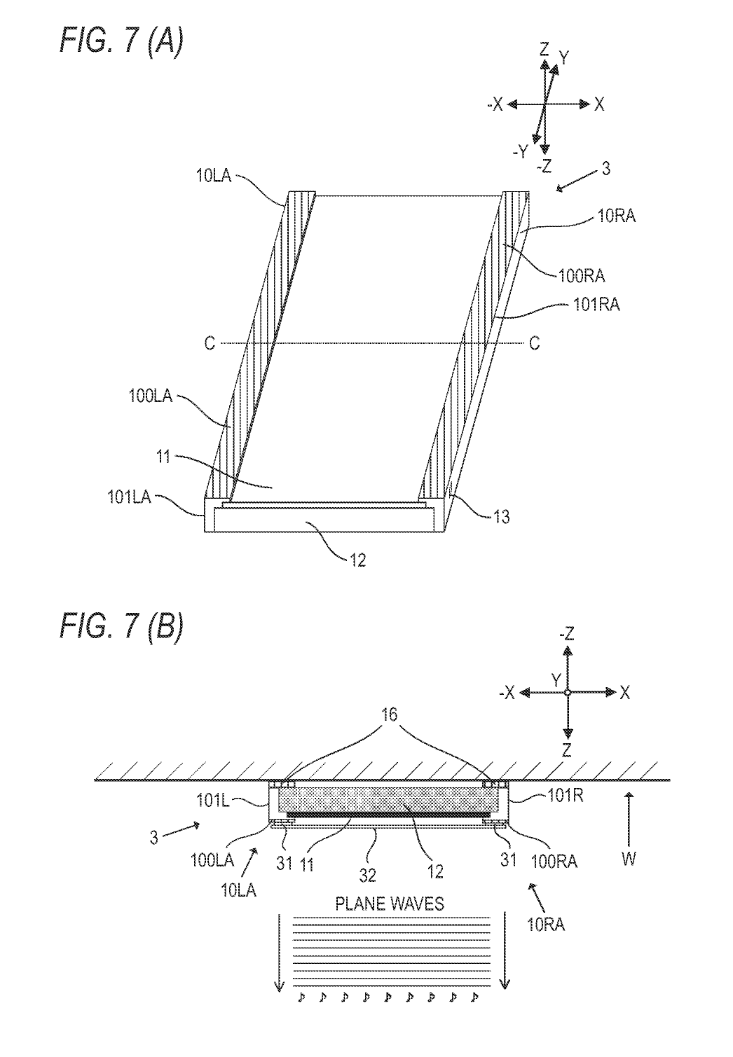

Then, a speaker 3 according to an embodiment 3 will be described referring to FIGS. 7(A) and 7(B). FIG. 7(A) is a perspective view of a lower face of the speaker 3. FIG. 7(B) is a sectional view of the speaker 3 in an installed state, taken along a line C-C. Description of a structure of the speaker 3 which is overlapped with that of the speaker 1 will be omitted.

The speaker 3 is different from the speaker 1 and the speaker 2 in that a medium (for example, a poster 32) can be repeatedly sticked to the front face. The speaker 3 includes a holding frame 10LA, a holding frame 10RA, the electrostatic speaker unit 11, and the sound absorbing sponge 12. The holding frame 10LA includes a front face part 100LA and a side face part 101LA. The holding frame 10RA includes a front face part 100RA and a side face part 101RA.

Polypropylene sheets are press-fitted to respective surfaces of the front face part 100LA and the front face part 100RA, by PP (;Poly-Propylene) process. As the results, the respective surfaces of the front face part 100LA and the front face part 100RA are made smooth, and increased in strength.

It is possible to apply the poster 32 to the front face part 100LA and the front face part 100RA, because the front face part 100LA and the front face part 100RA are provided at a front side of the speaker 3 ahead of the electrostatic speaker unit 11. Moreover, the electrostatic speaker unit 11 has a smooth front face, because the front face of the sound absorbing sponge 12 in contact therewith is smooth. Then, the poster 32 is abutted against the electrostatic speaker unit 11 which has the smooth front face, except the right and left edges, and becomes smooth, and therefore, an outer appearance of the speaker 3 is improved. Generally, paper medium such as the poster is likely to be broken, when its back face comes into contact with an undulated plane, and apart of the poster which is not tightly fitted to the undulated plane but floating may be pressed with a finger, for example. However, because the electrostatic speaker unit 11 which is in contact with the poster 32 has the smooth front face, the poster 32 is not easily broken, even when it is pressed with a finger, for example. Still further, the front face of the electrostatic speaker unit 11 which is exposed has the substantially same shape as the size A0 according to Japanese Industrial Standard of paper, and so, it is possible to output the plane waves from an almost entire surface of the poster 32.

Moreover, it is possible to repeatedly stick adhesive tapes 31 to the front face part 100LA and the front face part 100RA, because their respective surfaces are made smooth and increased in strength. However, even in case where the PP process is not applied to the front face part 100LA and the front face part 100RA, it is also possible to attach the poster 32 to the speaker 3 by means of adhesive tapes 31 respectively. It is to be noted that the poster 32 can be attached not only with the adhesive tapes 31 but with adhesive agent. Of course, it is also possible to attach the poster 32 to the front face of the speaker 1 according to the embodiment 1 or the speaker 2 according to the embodiment 2.

As described above, the speaker 3 which is thin-shaped, lightweight, and able to hold its shape can be used as a POP (; Point of Purchase) advertisement in combination with the poster 32 which is easily exchangeable.

This application is based on Japanese Patent Application filed on Feb. 27, 2013 (Japanese Patent Application No. 2013-037678), the contents of which are hereby incorporated by reference.

### INDUSTRIAL APPLICABILITY

According to the invention, it is possible to install the speaker on the ceiling or the wall, utilizing characteristics of the electrostatic speaker unit which is thin-shaped and lightweight, while suppressing interference.

### DESCRIPTION OF THE REFERENCE NUMERALS AND SIGNS

1, 2, 2A, 3 Speaker
10L, 10LA Holding frame
10R, 10RA Holding frame
11 Electrostatic speaker unit
12, 21 Sound absorbing sponge
13 Hole
14 Amplifier
15 Speaker cable
16 Double-faced tape
20 Case body
24 Interior of case body
22 Sound insulating material
23B, 23U Hook
100L, 100LA Front face part
100R, 100RA Front face part
101L, 101R Side face part
200, 201 Bracket

1. A speaker provided with an electrostatic speaker unit, the speaker comprising:
a sound absorbing material having a first face which is disposed on a side of a first face of the electrostatic speaker unit, and which has an area equal to or larger than an area of the first face of the electrostatic speaker unit; and
a holding member holding the electrostatic speaker unit and the sound absorbing material, wherein
a second face of the sound absorbing material, which is opposite to the first face thereof, is disposed so as to be opposed to a face of a sound insulating element, and
an area of the face of the sound insulating element is equal to or larger than the area of the first face of the electrostatic speaker unit.

2. The speaker according to claim 1, wherein
the face of the sound insulating element is a wall face.

3. The speaker according to claim 2, wherein
the holding member is attached to the wall face.

4. The speaker according to claim 1, wherein
the sound insulating element is a sound insulating material, and
the sound insulating material is abutted against the second face of the sound absorbing material.

5. The speaker according to claim 4, wherein
the holding member is in a shape of a case body which integrally contains the electrostatic speaker unit, the sound absorbing material, and the sound insulating material.

6. The speaker according to claim 1, wherein
the holding member is formed of a cardboard or a polypropylene foamed sheet.

7. The speaker according to claim 1, wherein
the holding member is provided with a medium attaching face, on a side opposed to a second face of the electrostatic speaker unit.

8. The speaker according to claim 7, wherein
the medium attaching face is formed of such material that a medium can be repeatedly removed therefrom.

9. The speaker according to claim 1, wherein
the sound insulating material is formed of polyurethane foam.
